(19) United States
(12) Patent Application Publication
(10) Pub. No.: US 2026/0126810 A1
(43) Pub. Date: May 7, 2026

(54) Remote Operator to Observe and Rectify On-Vehicle Safety Systems on Autonomous Work Vehicles

(71) Applicant: Autonomous Solutions, Inc., Mendon, UT (US)

(72) Inventors: Taylor Bybee, Mendon, UT (US); Mckay Colleni, Mendon, UT (US); Mckord Harris, Mendon, UT (US); James Yonk, Mendon, UT (US); Mike Hornberger, Mendon, UT (US); Mitch Torrie, Mendon, UT (US); Jeff Ferrin, Mendon, UT (US); Bret Turpin, Mendon, UT (US)

(73) Assignee: Autonomous Solutions, Inc., Mendon, UT (US)

(21) Appl. No.: 19/366,266

(22) Filed: Oct. 22, 2025

Related U.S. Application Data
(60) Provisional application No. 63/715,362, filed on Nov. 1, 2024.

(51) Int. Cl. G05D 1/639; G05D 1/223; G05D 1/224; G05D 1/622; G05D 105/15; G05D 107/20; G05D 109/10; G05D 111/10; G05D 111/30

(52) U.S. Cl. CPC G05D 1/642; G05D 1/2232; G05D 1/2247; G05D 1/622; G05D 2105/15; G05D 2107/21; G05D 2109/10; G05D 2111/17; G05D 2111/32

(57) ABSTRACT

Systems and methods are disclosed for a remote operator to observe and rectify safety issues on an autonomous work vehicle. For example, an autonomous work vehicle may detect an obstacle on or near a path within a work zone. The obstacle may be detected using a camera, a LiDAR or a RADAR. The autonomous work vehicle may stop prior to contacting the object. The autonomous work vehicle may also image the obstacle and send the image to a mobile device either directly or via a remote server. The user may determine the obstacle is not a safety issue or remove the obstacle from the path. In either case, the user may send an indication through the user interface that the path is clear and the autonomous work vehicle is safe to proceed along the path.

### BACKGROUND

Autonomous work vehicles can utilize onboard digital maps to guide steering and speed control systems along predefined routes within work sites. In many implementations, lidar, radar, or ultrasonic obstacle detection systems monitor the vehicle's path and trigger automatic slowing or full stops when obstructions are encountered. While effective for basic safety, these implementations typically lack integrated mechanisms for capturing detailed visual information about detected obstacles or for transmitting such information to remote operators in real time.

To improve situational awareness, certain systems have incorporated cameras to record images or video along the planned path. In these configurations, image processing algorithms may identify potential hazards, but the visual data is generally processed and stored locally. Remote users receive only summary alerts or processed detection flags, rather than raw or annotated images of the obstacles themselves, limiting the operator's ability to assess the nature and severity of the blockage.

Wireless transceivers have been added to some heavy machinery platforms to relay telemetry, status updates, and simple admission or clearance signals back to a central control station. These solutions enable remote monitoring of vehicle position, speed, and basic sensor alarms, yet they seldom support user-initiated confirmation workflows based on visual evidence. As a result, vehicles may remain halted until manual intervention occurs, without a structured mechanism for a user to confirm obstacle removal and trigger resumption of autonomous operation.

Other approaches have attempted to merge path guidance, obstacle detection, and remote communication by issuing generic stop alerts when an obstruction is detected. The alerts often contain minimal contextual information—such as timestamp and sensor classification—omitting precise map references and clear images of the obstacle. Consequently, operators receive insufficient detail to verify that an obstruction has been cleared, and vehicles may await arbitrary timeout intervals or manual overrides before proceeding.

### SUMMARY

Some examples disclosed in this document relate to an autonomous work vehicle including: a transceiver; an obstacle detection system; a digital storage medium; a steering control system; a speed control system; a camera; and a controller in communication with the camera, the speed control system, the steering control system, the digital storage medium, the obstacle detection system, and the transceiver, the controller: retrieves map data from the digital storage medium, the map defining features and a path within a work site; directs the autonomous work vehicle to drive on or near the path using the steering control system and the speed control system; detects an obstacle along the path using the obstacle detection system; in response to detecting the obstacle in the path, stops the autonomous work vehicle using the steering control system and/or the speed control system; records an image of the obstacle using the camera; sends the image of the obstacle to a user via the transceiver; receives a confirmation via the transceiver that the obstacle has been removed; and in response to receiving the confirmation, drives the autonomous work vehicle along the path using the steering control system and the speed control system.

Some examples disclosed in this document relate to an autonomous work vehicle, wherein the autonomous work vehicle includes one or more lights, and wherein the controller: turns on the lights in a first color when the autonomous work vehicle is following the path; and turns on the lights in a second color when the autonomous work vehicle is stopped after detecting an obstacle.

Some examples disclosed in this document relate to an autonomous work vehicle, wherein the autonomous work vehicle includes one or more speakers or sirens, and wherein the controller: transmits an audible alarm via the one or more speakers or sirens when the autonomous work vehicle is following the path; and stops transmitting the audible alarm via the one or more speakers or sirens when the autonomous work vehicle is following the path.

Some examples disclosed in this document relate to an autonomous work vehicle, wherein the obstacle detection system includes a LiDAR or a radar.

Some examples disclosed in this document relate to an autonomous work vehicle control system including: an autonomous work vehicle that autonomously follows a path by viewing it's surrounding with one or more sensors; and a mobile device with a graphical user interface that is in communication with the autonomous work vehicle the mobile device receives sensor data from the autonomous work vehicle when the autonomous work vehicle encounters an obstacle or has a blind spot; displays at least a portion of the sensor data to a user via the graphical user interface; receives one or more responses from the user via the graphical user interface whether to allow the autonomous work vehicle to do one or more of the following continue along the path, to stop, or to wait until the user removes the obstacle; and sends instructions to the autonomous work vehicle with instructions based on the received response from the user.

Some examples disclosed in this document relate to an autonomous work vehicle control system, wherein the sensor data includes a photographic image of a field of view from the perspective of the autonomous work vehicle.

Some examples disclosed in this document relate to an autonomous work vehicle control system, further including displaying one or more buttons to the user via the graphical interface, wherein each button allows the user to select one of continue, stop, or wait.

Some examples disclosed in this document relate to an autonomous work vehicle control system, further including displaying a button to the user via the graphical interface, wherein the button allows the user to instruct the autonomous work vehicle to proceed despite any obstacles, and the mobile device sends instructions to the autonomous work vehicle to proceed along the path despite the presence of an obstacle.

Some examples disclosed in this document relate to an autonomous work vehicle control system, further including displaying one or more buttons to the user via the graphical interface, wherein the buttons allow the user to indicate whether an obstacle has been visually detected by the user.

Some examples disclosed in this document relate to an autonomous work vehicle control system including: an autonomous work vehicle that can autonomously follow a path by viewing its surroundings with one or more sensors; and a mobile device with a graphical user interface that is in communication with the autonomous work vehicle, the mobile device displays on the graphical user interface a first widget that allows a user to turn on the autonomous work vehicle; in response to a user selecting the first widget, sending a signal to the autonomous work vehicle; receives sensor data from the autonomous work vehicle when the autonomous work vehicle encounters an obstacle in the autonomous work vehicle's path; displays at least a portion of the sensor data to a user via the graphical user interface; displays on the graphical user interface a second widget that allows a user to indicate whether the surroundings are clear; and in response to a user selecting the second widget, sending a signal to the autonomous work vehicle that it is safe to start operations.

Some examples disclosed in this document relate to an autonomous work vehicle control system, wherein the sensor data includes a photographic image of a field of view from the perspective of the autonomous work vehicle.

Some examples disclosed in this document relate to an autonomous work vehicle control system, wherein the photographic image is displayed on the mobile device.

Some examples disclosed in this document relate to an autonomous work vehicle control system, wherein the mobile device displays on the graphical user interface a map of a work area with the location of the autonomous work vehicle represented within the map.

Some examples disclosed in this document relate to a method operating on an autonomous work vehicle, the method including: directing the autonomous work vehicle along a path in a work zone defined by map data; detecting an obstacle on or near the path; in response to detecting the obstacle in the path, stopping the autonomous work vehicle prior to the obstacle; recording an image of the obstacle using a camera on the autonomous work vehicle; sending the image of the obstacle to a user via a transceiver; receiving a confirmation via the transceiver that the obstacle has been removed; and in response to receiving the confirmation, directing the autonomous work vehicle along the path.

Some examples disclosed in this document relate to a method, wherein directing the autonomous work vehicle along a path includes sending instructions to a steering control system and a speed control system of the autonomous work vehicle.

Some examples disclosed in this document relate to a method, wherein stopping the autonomous work vehicle includes sending instructions to a steering control system and a speed control system of the autonomous work vehicle.

Some examples disclosed in this document relate to a method, wherein the obstacle in the path is detected using an obstacle detection system of the autonomous work vehicle.

Some examples disclosed in this document relate to an autonomous work vehicle including: a transceiver; an obstacle detection system; a digital storage medium; a steering control system; a speed control system; a camera; and a controller in communication with the camera, the speed control system, the steering control system, the digital storage medium, the obstacle detection system, and the transceiver, the controller: retrieves map data from the digital storage medium, the map defining features and a path within a work site; directs the autonomous work vehicle to drive on or near the path using the steering control system and the speed control system; detects a blind spot on or near the path using the obstacle detection system, a blind spot is an area on the map that cannot be viewed by obstacle detection subsystem; in response to detecting the blind spot, stops the autonomous work vehicle using the steering control system and/or the speed control system; records an image of the blind spot using the camera; sends the image of the blind spot to a user via the transceiver; receives a confirmation via the transceiver that the autonomous work vehicle can safely proceed into the blind spot; and in response to receiving the confirmation, drives the autonomous work vehicle along the path and into the blind spot using the steering control system and the speed control system.

Some examples disclosed in this document relate to an autonomous work vehicle, wherein the autonomous work vehicle includes one or more lights, and wherein the controller: turns on the lights in a first color when the autonomous work vehicle is following the path; and turns on the lights in a second color when the autonomous work vehicle is stopped after detecting an obstacle.

Some examples disclosed in this document relate to an autonomous work vehicle, wherein the autonomous work vehicle includes one or more speakers or sirens, and wherein the controller: transmits an audible alarm via the one or more speakers or sirens when the autonomous work vehicle is following the path; and stops transmitting the audible alarm via the one or more speakers or sirens when the autonomous work vehicle is following the path.

Some examples disclosed in this document relate to an autonomous work vehicle, wherein the obstacle detection system includes a LiDAR or a radar.

### BRIEF DESCRIPTION OF THE FIGURES

FIG. 1 illustrates a block diagram of an example autonomous work vehicle communication system of the present disclosure.

FIG. 2 is a flowchart of a process for rectifying safety issues with an autonomous work vehicle after detecting an obstacle.

FIG. 3 is a flowchart of a process for starting an autonomous work vehicle.

FIG. 4 is a sideview of an autonomous tractor.

FIG. 5 is a sideview of an autonomous work vehicle.

FIG. 6 is an image of a graphical user interface (GUI) on a mobile device showing the stopped autonomous work vehicle in a map prior to operation.

FIG. 7 is an image of a GUI on a mobile device showing a first view from an autonomous work vehicle.

FIG. 8 is an image of a GUI on a mobile device showing a second view from an autonomous work vehicle.

FIG. 9 is an image of a GUI on a mobile device showing a second view from an autonomous work vehicle.

FIG. 10 image of a GUI on a mobile device showing options for the user to select an object type.

FIG. 11 is a block diagram of an example computational system (or controller).

### DETAILED DESCRIPTION

Autonomous work vehicles operate in and sense the environment using a number of sensors. Often there may be blind spots or other non-idealities in the sensor's field of view both collective and individual. In some cases, blind spots may result from low-quality sensor data that results in insufficient information for the autonomous work vehicle to make an informed decision. In addition, there may also be some uncertainty about the presence or absence of obstacles at startup or after a fault. These uncertainties may also be considered blind spots. Blind spots can result in incorrect performance, damage, or accidents. Systems and/or methods are disclosed for that can be used to allow an autonomous work vehicle to operate safely despite the possibility of blind spots.

For example, an autonomous work vehicle may detect an obstacle on or near a path within a work zone. The obstacle may be detected using a camera, a LiDAR or a RADAR. The autonomous work vehicle may stop prior to contacting the object. The autonomous work vehicle may also image the obstacle and send the image to a mobile device either directly or via a remote server. The user may determine the obstacle is not a safety issue or remove the obstacle from the path. In either case, the user may send an indication through the user interface that the path is clear and the autonomous work vehicle is safe to proceed along the path.

As another example, an autonomous work vehicle may detect a blind spot within a work zone. A blind spot may be an area with the work zone that sensors or cameras on the autonomous work vehicle may not be able detect, sense, or image yet a map shows that the area exists. The blind spot may be identified using a camera, a LiDAR or a RADAR. The autonomous work vehicle may stop prior to contacting the object. The autonomous work vehicle may also image the blind spot and the area around the blind spot, and send the image to a mobile device either directly or via a remote server. The user may determine the blind spot is not a safety issue. In either case, the user may send an indication through the user interface that the path is clear and the autonomous work vehicle is safe to proceed along the path.

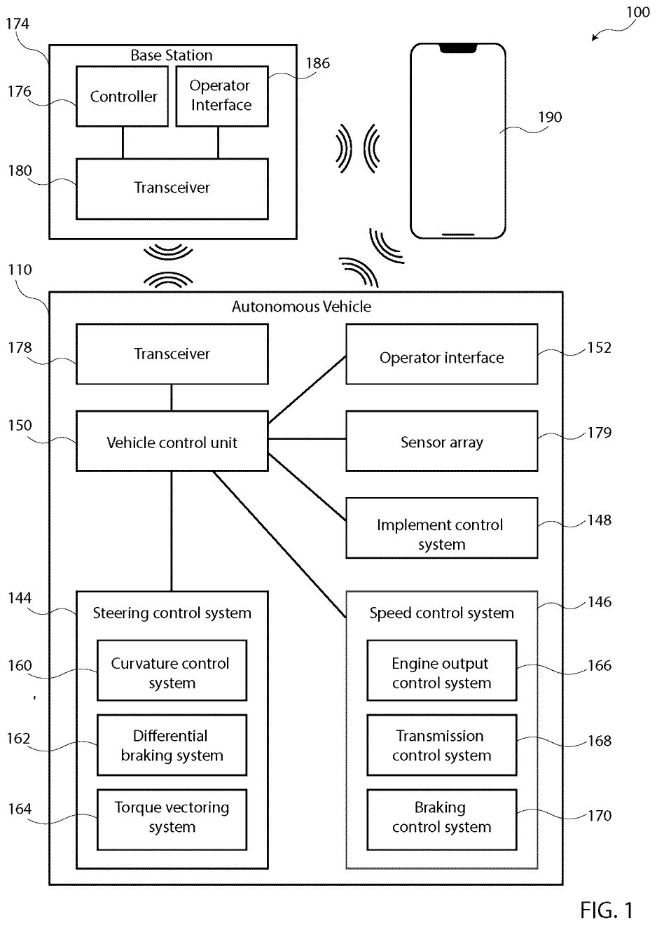

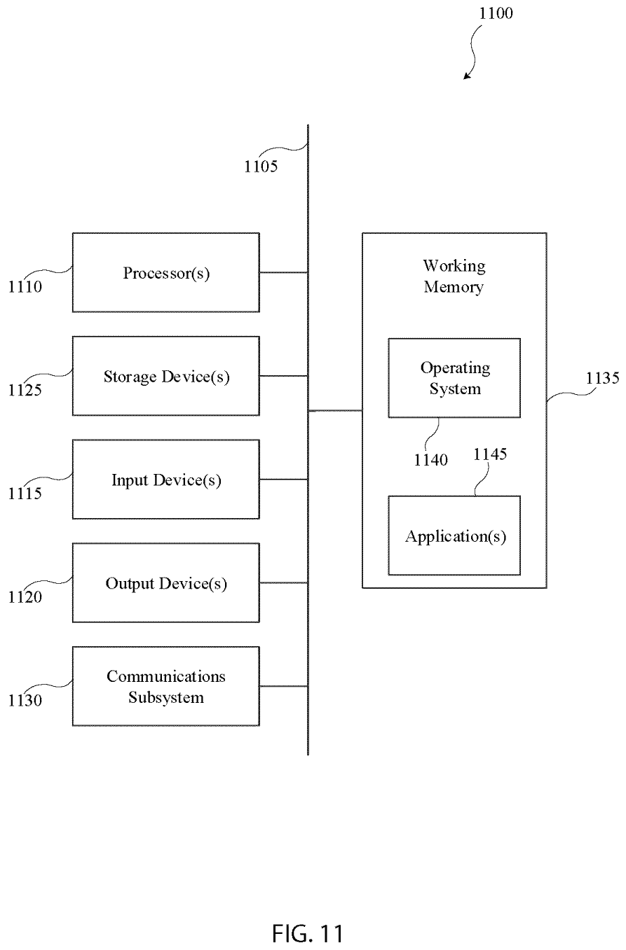

FIG. 1 is a block diagram of a communication and control system 100 that may be utilized in conjunction with the systems and methods of the disclosure. The communication and control system 100 may include a vehicle control unit 150 which may be mounted on an autonomous work vehicle 110. The autonomous work vehicle 110, for example, may include a tractor, a mower, yard truck, loader, wheel loader, track loader, dump truck, digger, backhoe, forklift, etc. The communication and control system 100, for example, may include any or all components of computational system 1100 shown in FIG. 11.

For example, the autonomous work vehicle 110 may include a steering control system 144 that may control a direction of movement of the autonomous work vehicle 110. The steering control system 144, for example, may include any or all components of computational system 1100 shown in FIG. 11.

The autonomous work vehicle 110, for example, may include a speed control system 146 that controls the speed, acceleration, and deceleration of the autonomous work vehicle 110. The speed control system 146, for example, may control the speed of the autonomous work vehicle 110 based on map data, occlusion data, control algorithms, obstacle detection, start and/or stop points, input from the autonomous server 174, etc. The speed control system 146, for example, may include any or all components of computational system 1100 shown in FIG. 11.

The autonomous work vehicle 110, for example, may include an implement control system 148 that may control operation of an implement towed the autonomous work vehicle 110 or integrated within the autonomous work vehicle 110 or coupled to the autonomous work vehicle 110. The implement control system 148 may, for example, may include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, mower, reel drive, reel, disc, harrow, blower, etc. The implement control system 148, for example, may include any or all components of computational system 1100 shown in FIG. 11.

The vehicle control unit 150 may be communicatively coupled with the steering control system 144, the speed control system 146, and the implement control system 148. The vehicle control unit 150, for example, may include any or all the components show in FIG. 11. The vehicle control unit 150, for example, may be integrated into a single controller or may include a plurality of distinct components or controllers. The vehicle control unit 150 may also be coupled with one or more sensors from the sensor array 179 and receive sensor data from the sensor array 179.

The vehicle control unit 150, for example, may be used to control various aspects of the vehicle such as, for example, sending instructions to the steering control system 144, implement control system 148, speed control system 146, etc. The vehicle control unit 150, for example, may include a vehicle artificial intelligence that may include one or more processors that execute one or more algorithms.

The vehicle control unit 150, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensor array 179 or from autonomous server 174.

The vehicle control unit 150, for example, may be an electronic controller with electrical circuitry configured to process data from the various components of the autonomous work vehicle 110. The vehicle control unit 150 may include any or all a processor, such as the processor 1110, and a working memory 1135. The vehicle control unit 150 may also include one or more storage devices and/or other suitable components of computational system 1100. The processor 154 may be used to execute software, such as software for calculating drivable path plans. Moreover, the processor 154 may include multiple microprocessors, one or more “general-purpose” microprocessors, one or more special-purpose microprocessors, and/or one or more application specific integrated circuits (ASICS), or any combination thereof. For example, the processor 154 may include one or more reduced instruction set (RISC) processors. The vehicle control unit 150, for example, may include any or all the components show in FIG. 11.

The vehicle control unit 150, for example, may include a volatile memory, such as random access memory (RAM), and/or a nonvolatile memory, such as ROM (e.g., working memory 1135 and/or storage device 1125). The memory may store a variety of information and may be used for various purposes. For example, the memory may store processor-executable instructions (e.g., firmware or software) for the vehicle control unit 150 to execute, such as instructions for calculating drivable path plan, and/or controlling the autonomous work vehicle 110. The memory may include flash memory, one or more hard drives, or any other suitable optical, magnetic, or solid-state storage medium, or a combination thereof. The memory may store data such as field maps, maps of desired paths, vehicle characteristics, software or firmware instructions, occlusion maps, and/or any other suitable data.

The steering control system 144, for example, may include a curvature rate control system 160, a differential braking system 162, a steering mechanism, and a torque vectoring system 164 that may be used to steer the autonomous work vehicle 110. The curvature rate control system 160, for example, may control a direction of an autonomous work vehicle 110 by controlling a steering control system of the autonomous work vehicle 110 with a curvature rate, such as an Ackerman style autonomous work vehicle or articulating vehicle. The curvature rate control system 160, for example, may automatically rotate one or more wheels or tracks of the autonomous work vehicle 110 via hydraulic or electric actuators to steer the autonomous work vehicle 110. By way of example, the curvature rate control system 160 may rotate front wheels/tracks, rear wheels/tracks, and/or intermediate wheels/tracks of the autonomous work vehicle 110 or articulate the frame of the vehicle, either individually or in groups. The differential braking system 162 may independently vary the braking force on each lateral side of the autonomous work vehicle 110 to direct the autonomous work vehicle 110. Similarly, the torque vectoring system 164 may differentially apply torque from the engine to the wheels and/or tracks on each lateral side of the autonomous work vehicle 110. While the steering control system 144 includes the curvature rate control system 160, the differential braking system 162, and the torque vectoring system 164, the steering control system 144 may include one or more of these systems. Further examples may include a steering control system 144 having other and/or additional systems to facilitate turning the autonomous work vehicle 110 such as an articulated steering control system, a differential drive system, and the like.

The speed control system 146, for example, may include an engine output control system 166, a transmission control system 168, and a braking control system 170. The engine output control system 166 may vary the output of the engine to control the speed of the autonomous work vehicle 110. For example, the engine output control system 166 may vary a throttle setting of the engine, a fuel/air mixture of the engine, a timing of the engine, and/or other suitable engine parameters to control engine output. In addition, the transmission control system 168 may adjust gear selection within a transmission to control the speed of the autonomous work vehicle 110. Furthermore, the braking control system 170 may adjust braking force to control the speed of the autonomous work vehicle 110. While the speed control system 146 includes the engine output control system 166, the transmission control system 168, and the braking control system 170, the speed control system 146 may include one or two of these systems. The speed control system 146, for example, may also include other systems and/or additional systems that may be used to control the speed of the autonomous work vehicle 110.

The implement control system 148, for example, may control various parameters of the implement towed by and/or integrated within the autonomous work vehicle 110. For example, the implement control system 148 may instruct an implement controller via a communication link, such as a CAN bus, ISOBUS, Ethernet, wireless communications, and/or Broad R Reach type Automotive Ethernet, etc.

The implement control system 148, for example, may instruct an implement controller to adjust a penetration depth of at least one ground engaging tool of an agricultural implement, which may reduce the draft load on the autonomous work vehicle 110.

The implement control system 148, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc.

The implement control system 148, as another example, may instruct the implement controller to adjust a mower blade height or reel drive height, etc.

The communication and control system 100, for example, may include a sensor array 179. The sensor array 179, for example, may facilitate determination of condition(s) of the autonomous work vehicle 110 and/or the work area. For example, the sensor array 179 may include one or more sensors (e.g., infrared sensors, ultrasonic sensors, magnetic sensors, tachometer, radar sensors, Lidar sensors, terahertz sensors, sonar sensors, wheel encoders, cameras, etc.) that monitor a rotation rate of a respective wheel or track and/or a ground speed of the autonomous work vehicle 110. The sensors may also monitor operating levels (e.g., temperature, fuel level, etc.) of the autonomous work vehicle 110. Furthermore, the sensors may monitor conditions in and around the work area, such as temperature, weather, wind speed, compass, humidity, and other conditions. The sensors of the sensor array 179, for example, may detect physical objects in the work area, such as a parking stall, a material stall, accessories, other vehicles, obstacles, environmental features, or other object(s) that may in the area surrounding the autonomous work vehicle 110.

The sensor array 179, for example, may include a velocity sensor which may include one or more of an inertial measurement unit, a compass, a GPS sensor, a wheel encoder, a tachometer, a camera, a radar, an ultrasonic sensors, a 3D LIDAR sensor, a 2D LIDAR sensor, a radar, a photo-electric sensor, etc. The sensor array 179, for example, may also include a steering angle sensor. The velocity sensor, for example, may produce velocity data. Velocity data may include speed and/or bearing. Velocity data, for example, may also include steering angular rate.

The operator interface 152, for example, may be communicatively coupled to the vehicle control unit 150 and configured to present data from the autonomous work vehicle 110 via a display. Display data may include data associated with operation of the autonomous work vehicle 110, data associated with operation of an implement, a position of the autonomous work vehicle 110, a speed of the autonomous work vehicle 110, a desired path, a drivable path plan, a target position, a current position, etc. The operator interface 152 may enable an operator to control certain functions of the autonomous work vehicle 110 such as starting and stopping the autonomous work vehicle 110, inputting a desired path, etc. The operator interface 152, for example, may enable the operator to input parameters that cause the vehicle control unit 150 to adjust the drivable path plan. For example, the operator may provide an input requesting that the desired path be acquired as quickly as possible, that an off-path normal error be minimized, that a speed of the autonomous work vehicle 110 remain within certain limits, that a lateral acceleration experienced by the autonomous work vehicle 110 remain within certain limits, etc. In addition, the operator interface 152 (e.g., via the display, or via an audio system (not shown), etc.) may alert an operator if the desired path cannot be achieved, for example.

The communication and control system 100, for example, may include a autonomous server 174 having a autonomous server controller 176 located remotely from the autonomous work vehicle 110. For example, the control functions of the vehicle control unit 150 may be distributed between the vehicle control unit 150 of the vehicle control unit 150 and the autonomous server controller 176. The autonomous server controller 176, for example, may perform a substantial portion of the control functions of the vehicle control unit 150. For example, a first transceiver 178 positioned on the autonomous work vehicle 110 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 180 at the autonomous server 174. The autonomous server controller 176, for example, may calculate drivable path plans and/or output control signals to control the curvature rate control system 160, the speed control system 146, and/or the implement control system 148 to direct the autonomous work vehicle 110 toward the desired path, for example. The autonomous server controller 176 may include a processor and memory device having similar features and/or capabilities as the processor and the memory device discussed previously. Likewise, the autonomous server 174 may include an operator interface 186 having a display 188, which may have similar features and/or capabilities as the operator interface 152 and the display discussed previously.

In some embodiments, whether or both the autonomous server 174 and/or the autonomous work vehicle 110 may be in communication with a mobile device 190. A mobile device my include a phone, tablet, laptop, or computer. The mobile device 190, for example, can include an application that allows the user to communicate commands to the autonomous work vehicle 110 and/or receive information about the autonomous work vehicle 110. Alternatively or additionally, the mobile device 190, for example, can include an application that allows the user to observe the autonomous work vehicle 110 move through a map of the work area where the autonomous work vehicle operates. Alternatively or additionally, the mobile device 190, for example, can include an application that allows the user to observe various occlusions found within the environment and shown on a map.

The mobile device 190, for example, can include software that allows a user to initiate data collection at the autonomous work vehicle. The mobile device 190, for example, can include software that allows a user to observe the state of an implement (e.g., on, off, position, etc.) attached with the autonomous work vehicle. The mobile device 190, for example, can include software that allows a user to stream or record sensor data such as, for example, vehicle speed, images, video, etc.

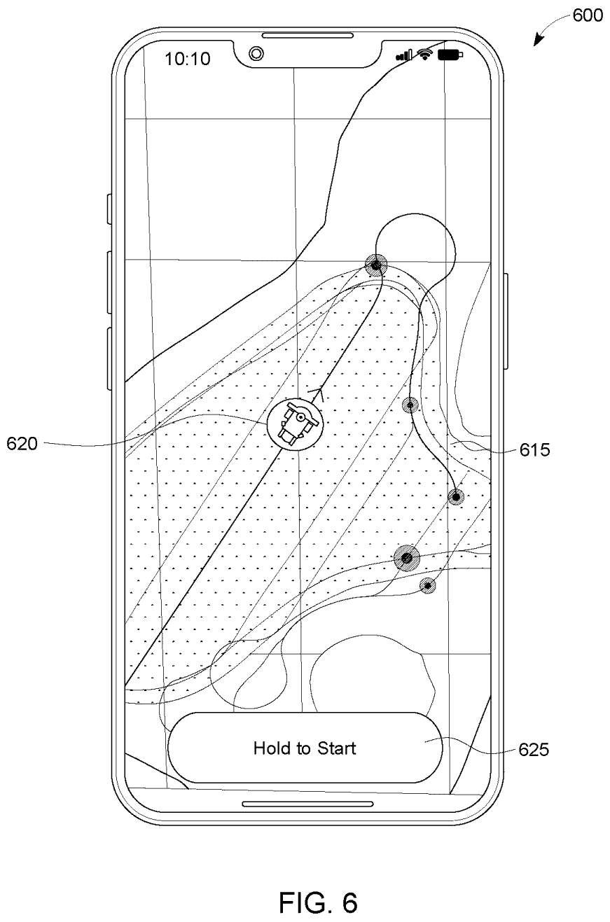

The mobile device 190, for example, may include an application that can display any of the GUIs shown in FIGS. 6-10. The mobile device 190, for example, may include an application that can receive any of the user inputs disclosed in this document. The mobile device 190, for example, may include an application that can display any of the information disclosed in this document.

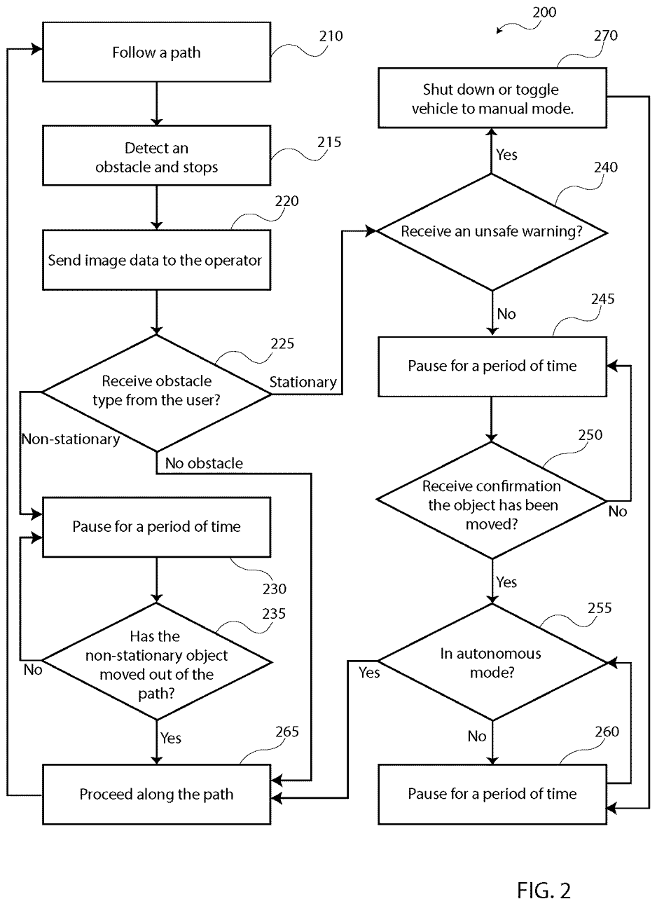

FIG. 2 is a flowchart of a process 200 for rectifying safety issues with an autonomous work vehicle after detecting an obstacle. The various blocks in process 200 can occur in any order. Additionally or alternatively, one or more blocks may be skipped, one or more blocks may be performed in parallel, and/or one or more blocks may be combined, and/or one or more blocks may be performed in any number of sub-blocks.

Process 200, for example, can be executed by vehicle control unit 150.

Process 200 begins at block 205 where an autonomous work vehicle (e.g., autonomous work vehicle 110, autonomous tractor 400, autonomous work vehicle 500, etc.) is proceeding down a path. The path may define the operation of the autonomous work vehicle within the environment and may include speed information, turn information, implement positions, vectors, etc. that the autonomous work vehicle follows throughout and at different points within the environment. The path, for example, may be received from the autonomous server 174 and/or from the mobile device 190. The path may be defined within a map that defines the environment and the various paths for the autonomous work vehicle.

While the autonomous work vehicle is operating, for example, warning lights (e.g., lights 420) on the autonomous work vehicle may be turned on in a first color, such as, for example, in yellow or orange.

While the autonomous work vehicle is operating, for example, one or more speakers or sirens on the autonomous work vehicle may transmit a first audible alarm. when the autonomous work vehicle has stopped operating, for example, one or more speakers or sirens on the autonomous work vehicle may transmit an audible alarm. And when the autonomous work vehicle begins to slow down, for example, the one or more speakers or sirens on the autonomous work vehicle may transmit a second audible alarm, which is different than the first audible alarm.

At block 215, the autonomous work vehicle may detect an obstacle on the path or determine a blind spot within the sensor array. The obstacle, for example, may be identified using one or more sensors of the sensor array 179 and or obstacle detection algorithm. Once the obstacle has been detected or the blind spot determined, the autonomous work vehicle may come to a stop. When the autonomous work vehicle stops, the warning lights 420 may change color such as, for example, to a red color. And any alarms being transmitted from one or more speakers may stop being transmitted.

A blind spot may be detected using any type of algorithm such as, for example, a point cloud occlusion mapping algorithm. An example, point cloud occlusion mapping algorithm is disclosed in U.S. Pat. No. 11,919,525, which is incorporated into this application by reference for all purposes.

At block 220, the autonomous work vehicle sends one or more images of the surroundings to a user either directly to the mobile device 190 or to the mobile device 190 via the autonomous server 174. At the mobile device, the user can review the one or more images and confirm whether there are any obstacles or worrisome blind spots. The one or more images may include one or more camera images, video segments, Lidar point clouds, radar point clouds, etc. Along with the image, the autonomous work vehicle may also send sensor status information or other information that can be presented as visualization or text to the user via the mobile device 190.

With the one or more images on the mobile device, the user can inspect the one or more images and make an informed decision if the one or more images show obstacles or blind spots or other information in the scene which may indicate undesirably high risk for operation of the autonomous work vehicle.

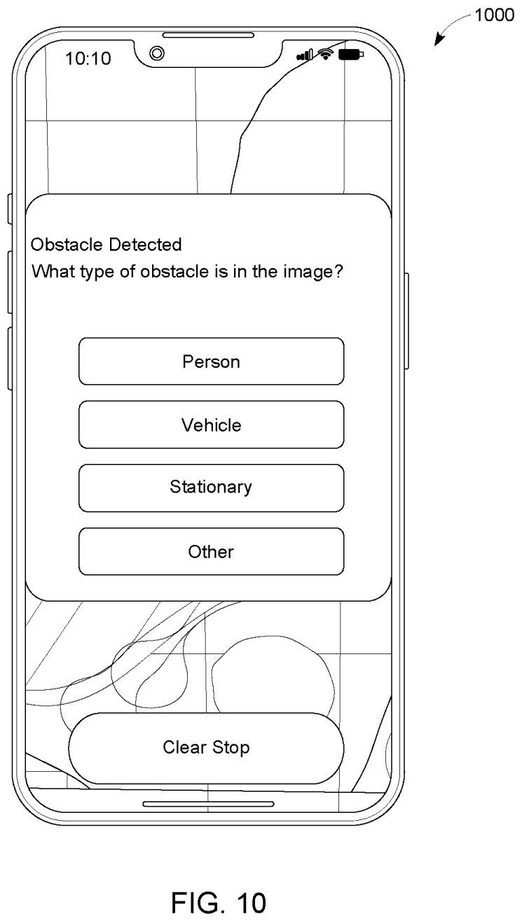

At the mobile device 190, for example, the user may be prompted to select the obstacle type. FIG. 10 shows an example screen shot of possible selections for a user. In this example, the user may choose one of the following obstacle types: “Person”, “Vehicle”, “Stationary”, and “Other”. The “Person” and/or “Vehicle” options may be considered nonstationary objects. Other options, for example, may allow the user to select whether the obstacle is stationary or nonstationary. Other options, for example, may allow the user to select whether a blind spot is problematic or not problematic. Other options, for example, may allow the user to select whether the autonomous work vehicle should stop all autonomous functionality or whether the autonomous work vehicle should continue with the autonomous functionality.

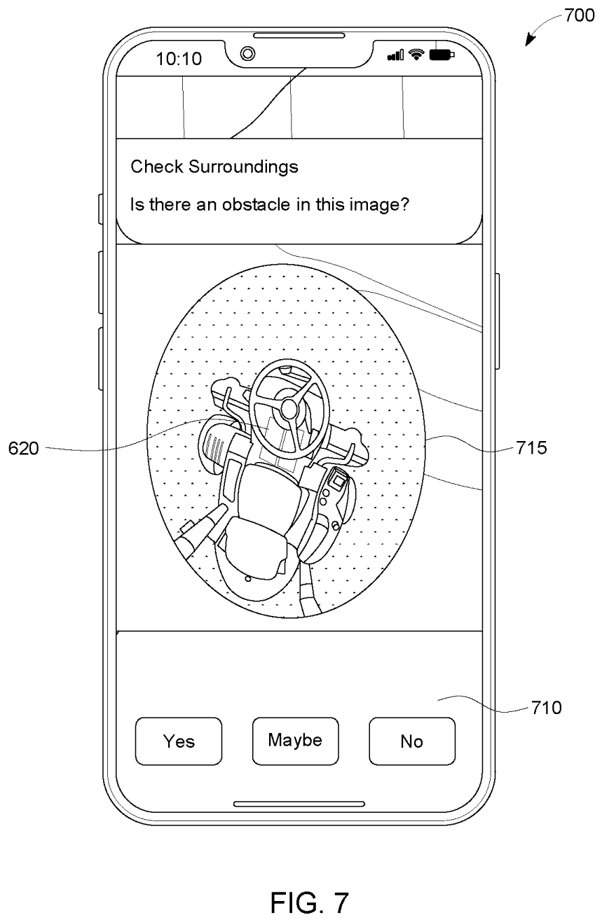

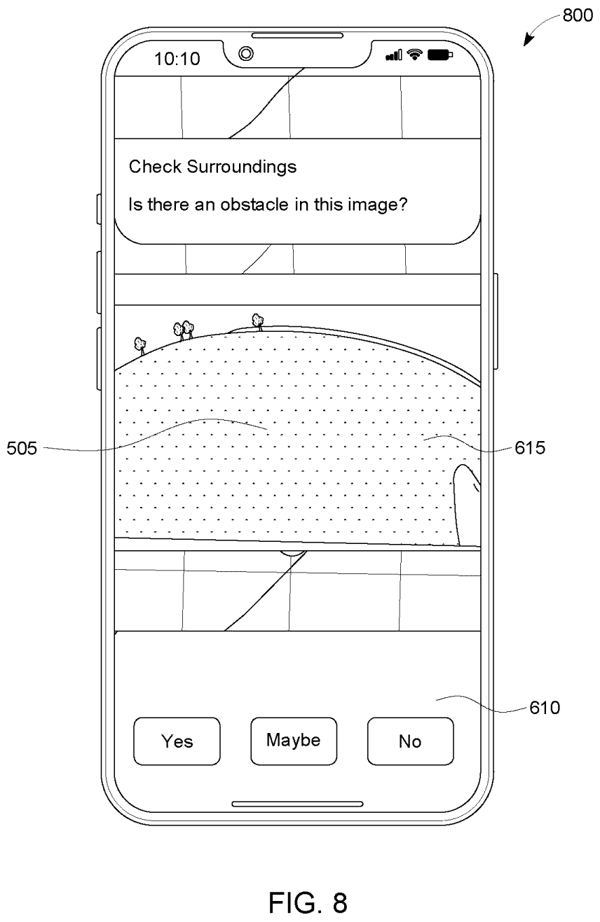

Alternatively or additionally, FIG. 7 illustrates an example user interface on a mobile device that allows a user to view a 360 image of the surroundings around the autonomous work vehicle. FIG. 8 illustrates an example user interface on a mobile device that allows a user to view a front image of the surroundings around the autonomous work vehicle. In both FIG. 7 and FIG. 8, the user interface provides buttons 710 that allow the user to select whether there is an obstacle (“Yes”), not an obstacle (“No”), or there might be an obstacle (“Maybe”). Alternatively, the user interface may allow the user to select other options as mentioned above. The user's response may be sent to the autonomous server 174 and/or the autonomous work vehicle.

The one or more images may be stored at the autonomous work vehicle, autonomous server, or mobile device.

At block 225, the autonomous work vehicle can receive information from the user about the obstacle type. If the received obstacle type is stationary, process 200 proceeds to block 240. If the received obstacle type is nonstationary, process 200 proceeds to block 230. If the received obstacle type indicates there is no obstacle, process 200 proceeds to block 265.

The obstacle type information received at block 225 may be stored at the autonomous work vehicle, autonomous server, or mobile device.

At block 230, the autonomous work vehicle can wait a period of time (e.g., 30, 60, 120, 180, 300 seconds) before determining whether the nonstationary object has moved. If the nonstationary object has not moved out of the path, process 200 can return to block 230. If the nonstationary object has moved out of the path, process 200 can proceed to block 265. At block 265, the autonomous work vehicle can again proceed along the path.

If the nonstationary object does not move after a predetermined period of time, such as, for example, if the user misdiagnoses the object as nonstationary, the process 200 may proceed back to block 220. For example, if the process loops between blocks 235 to 230 more than a predetermined number of times, process 200 may proceed back to block 220.

If the obstacle type is considered stationary, the application operating on the mobile device 190 may notify the user via the GUI on the mobile device 190 to move the stationary obstacle.

When the user approached the autonomous work vehicle to remove the obstacle, the user may change an emergency stop switch from operate to stopped. This emergency stop switch may be handheld device that is the same as or separate from the mobile device 190 that a user can toggle between operate and stopped. When toggled to operate, the autonomous work vehicle may be free to operate. When toggled to stopped, the autonomous work vehicle become inoperable. This emergency stop switch can allow a user to make sure the autonomous work vehicle is not operable when the user is nearby and investigating the stationary obstacle.

At block 240, the autonomous work vehicle can determine whether it received an indication from the user via the mobile device that the obstacle or surroundings are not safe. If no indication has been received or the indication notes that it is safe, process 200 can proceed to block 245.

If an indication has been received specifying that it is unsafe, the process 200 proceeds to block 270 where the autonomous work vehicle is either powered down or toggled to manual mode or stopped via an emergency stop mode. In manual mode, the autonomous work vehicle is no longer autonomous such that the vehicle control unit 150 is no longer able to control the operation of the vehicle. After block 270, the process 200 may proceed to block 260 or end. Alternatively or additionally, after block 270, the process 200 may proceed to block 250.

The user indication received at block 240 may be stored at the autonomous work vehicle, autonomous server, or mobile device.

In some embodiments, block 240 and block 265 may be skipped or not used. In such embodiments, after block 225, process 200 proceeds to block 245.

At block 245, the process 200 can pause of a period of time prior to proceeding to block 250. At block 250, the process can determine whether it has received confirmation from the user that the user has removed the obstacle from the path. If the user has not confirmed that the obstacle has been removed, process 200 can return to block 245. If the user has confirmed that the obstacle has been removed, process 200 proceeds to block 255.

Alternatively or additionally, at block 250, if the user has confirmed that the obstacle has been removed, the on-vehicle software system may choose to re-baseline an occlusion map or state to clear any previously determined occluded areas within the environment. The may also indicate that certain areas that were presented to the remote operator have been deemed safe to traverse despite having been considered blind spots or containing obstacles.

The autonomous work vehicle, for example, may keep track of portions of the environment where the one or more sensors from the sensor array 179 has or has not observed around the vehicle, which may be considered an occlusion map. The autonomous work vehicle can then operate in such a way to avoid these occlusions on the map, which may be considered obstacles. At block 250, the user can override the occlusion map and obstacle detection by telling the system that these occluded areas in the environment are observed to be free of obstacles.

At block 255, if needed, the autonomous work vehicle can determine whether it has been toggled into manual mode and then back to autonomous mode. This can be done, for example, either manually at the autonomous work vehicle or via software by the user operating the mobile device. For example, the autonomous work vehicle may include a physical switch that toggles the autonomous work vehicle into autonomous mode in one position and into manual mode in another position. At block 225, the autonomous work vehicle may confirm that the autonomous work vehicle has been toggled into manual mode and back into autonomous mode.

As another example, the autonomous work vehicle may be togged into manual mode using a software application either at the autonomous server 174 or at a mobile device in communication with either the autonomous server 174 or the autonomous work vehicle.

By requiring the user to toggle the autonomous work vehicle into and out of manual mode at block 255, may provide a safety step that requires user input to ensure there are no longer obstacles present and/or individuals present that are removing obstacles.

In some embodiments, the process 200 may skip block 255.

If the autonomous work vehicle has not been toggled into and out of manual mode at block 255, then process 200 may proceed to block 260, where the process is paused for a period of time prior to returning to block 225.

If the autonomous work vehicle has been toggled into and out of manual mode at block 255, then process 200 may proceed to block 265.

At block 265, the autonomous work vehicle may receive confirmation from the user that the obstacle, whether stationary or nonstationary has been removed from the path. The user, for example, can indicate on the mobile device or the autonomous server 174 that the obstacle has been removed. Alternatively or additionally, the user may also change the emergency stop switch from stopped to operate.

Once confirmation has been received at block 265, the autonomous work vehicle can proceed along the path at block 270. When the autonomous work vehicle is proceeding along the path, the warning lights (e.g., warning lights 420) may be changed to illuminate in the first color.

After block 265, the process 200 may proceed back to block 210.

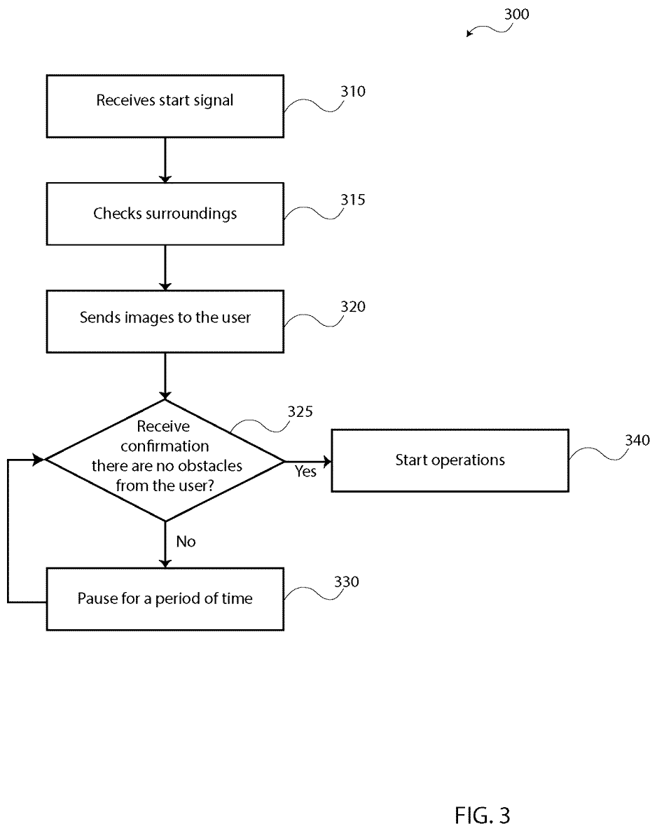

FIG. 3 is a flowchart of a process 300 for starting an autonomous work vehicle such as, for example, at startup or after a fault. The order of the various blocks in process 300 can occur in any order. Additionally or alternatively, one or more blocks may be skipped, one or more blocks may be performed in parallel, and/or one or more blocks may be combined, and/or one or more blocks may be performed in any number of sub-blocks.

The process 300, for example, can be executed by vehicle control unit 150.

The process 300 can start at block 310 where an autonomous work vehicle may receive a start signal. The start signal may be received from a autonomous server 174 or a mobile device 190. For example, a user may operate a mobile device 190 with an autonomous work vehicle control application on in communication with the autonomous server 174. The user may press a start button (or any other type of widget; e.g., slider, dropdown, etc.) on the mobile device that results in a start signal being sent from the autonomous server 174 to the autonomous work vehicle. Alternatively, for example, a user may operate a mobile device 190 with an autonomous work vehicle control application that is in communication with the autonomous work vehicle 110. The user may press a start button (or any other type of widget; e.g., slider, dropdown, etc.) on the mobile device that results in a start signal being sent from the autonomous server 174 to the autonomous work vehicle.

FIG. 6 illustrates an example GUI on a mobile device that allows the user to activate the start signal.

At block 315, in response to receiving the start signal, the autonomous work vehicle checks its surrounding using one or more sensors from the sensor array 179.

At block 320, the autonomous work vehicle sends one or more images of the surroundings to the user via the autonomous server 174. These one or more images may ultimately be sent to the mobile device. The user can then review the one or more images and confirm whether there are any obstacles. The one or more images may include one or more camera images, video segments, Lidar point clouds, and/or radar point clouds. Along with the image, the autonomous work vehicle may also send sensor status or other information that can be presented as visualization or text.

With the one or more images on the mobile device, the user can inspect the one or more images and make an informed decision if the one or more images show obstacles or other information in the scene which may indicate undesirably high risk for operation of the autonomous work vehicle.

The one or more images may be stored at the autonomous work vehicle, autonomous server, or mobile device.

FIG. 7 illustrates an example user interface on a mobile device that allows a user to view a 360 image of the surroundings around the autonomous work vehicle. FIG. 8 illustrates an example user interface on a mobile device that allows a user to view a front image of the surroundings around the autonomous work vehicle. In both FIG. 7 and FIG. 8, the user interface provides buttons that allow the user to select whether there is an obstacle (“Yes”), not an obstacle (“No”), or there might be an obstacle (“Maybe”). The user's response may be sent to the autonomous server 174 and/or the autonomous work vehicle.

At block 325, if the confirmation is received by the autonomous work vehicle that the user has confirmed that there is no obstacle, then process 300 proceeds to block 340 and the autonomous work vehicle starts its normal operation such as, for example, as defined by or communicated from the autonomous server. The user confirmation may be stored at the autonomous work vehicle, autonomous server, or mobile device.

If no confirmation has been received, then process 300 may pause for a period of time (e.g., 10-20 seconds) at block 330 before returning to block 325. If no confirmation has been received after a longer period of time, the process 300 may end.

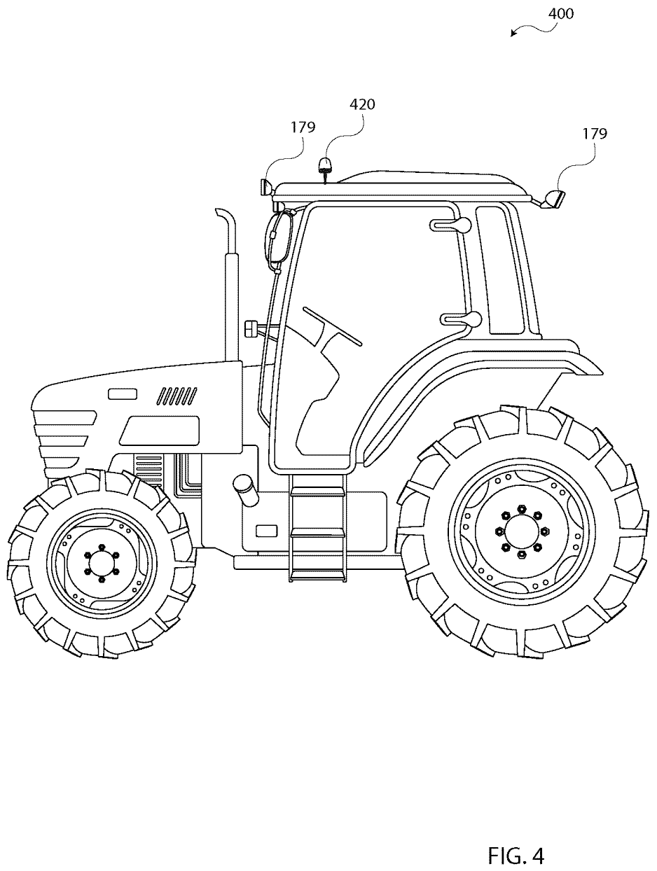

FIG. 4 is a sideview of an example autonomous tractor 400, which may include all or some of the components of autonomous work vehicle 110. In this example, the autonomous tractor 400 may include standard tractor equipment and/or components. The autonomous tractor 400 may include or be coupled with any kind of implement such as, for example, plow, disc plow, reel mower, dumper, lift, bucket, shovel, blade, cutter, etc. The autonomous tractor 400, for example, includes a sensor array 179 (or multiple sensor arrays). The sensor array 179 may include, for example, one or more lidar, radar, and/or video cameras. The video cameras, for example, may include 360 degree cameras, a front facing camera, and/or a back facing camera.

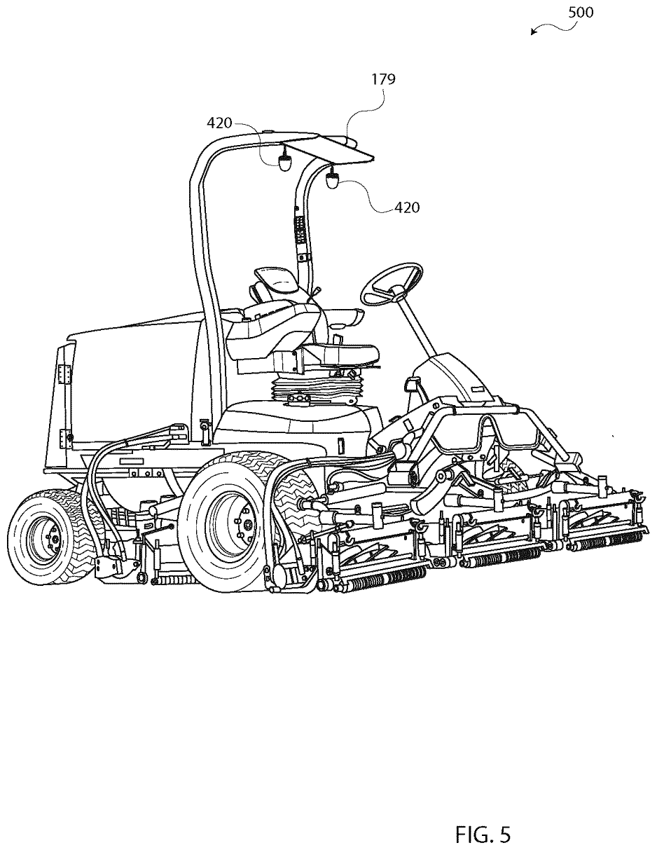

FIG. 5 is a sideview of an example autonomous work vehicle 500, which may include all or some of the components of autonomous work vehicle 110. In this example, the autonomous work vehicle 500 includes a disc mower 545. Any type of mower or blades may be used instead of the disc mower. The autonomous work vehicle 500, for example, includes a sensor array 179 (or multiple sensor arrays). The sensor array 179 may include, for example, one or more lidar, radar, and/or video cameras. The video cameras, for example, may include 360 degree cameras, a front facing camera, and/or a back facing camera.

FIG. 6 shows a GUI 600 of a screen of a mobile device showing a GUI with an image of the stopped autonomous work vehicle in a map prior to operation. The image on the screen shows an autonomous work vehicle 620, which in this case is a an autonomous work vehicle, navigating through a map 615 of a golf course. The screen also includes a start button 625 that can be pressed by a user to start the process 300 at block 310. Any other type of autonomous work vehicle may be used in any other work location.

FIG. 7 shows a GUI 700 of a screen of a mobile device showing a first image of the surroundings from the autonomous work vehicle 620. In this example, the GUI 700 shows a 360 view image 715 of an autonomous work vehicle 620 in its surroundings. The GUI 700 also shows buttons allowing the user to indicate whether there is an obstacle surrounding the autonomous work vehicle 620.

FIG. 8 shows a GUI 800 of a screen of a mobile device showing a second view from an autonomous work vehicle 620. In this example, the GUI 800 shows a different image 815 of view from an autonomous work vehicle 620 in its surroundings taken by a camera on the autonomous work vehicle 620. The GUI 800 also shows buttons allowing the user to indicate whether there is an obstacle surrounding the autonomous work vehicle 620. The GUI 800 also shows buttons allowing the user to indicate whether there is an obstacle surrounding the autonomous work vehicle 620.

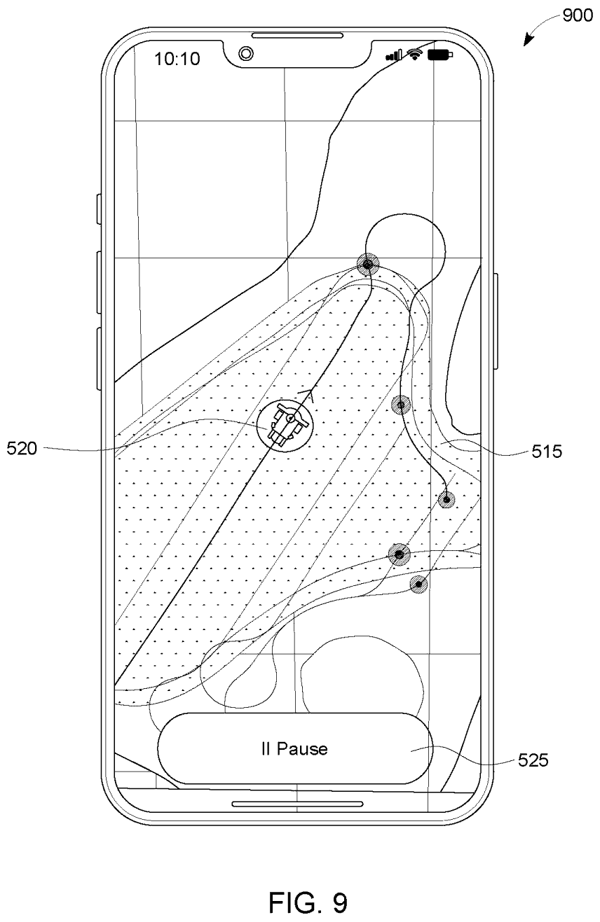

FIG. 9 shows a GUI 900 of a screen of a mobile device showing the operating autonomous work vehicle 620 in a map 615. In this example, GUI 900 includes a button 925 that when pressed pauses operation of the autonomous work vehicle 620.

FIG. 10 shows a GUI 1000 of a screen of a mobile device showing the operating autonomous work vehicle 620 in a map. In this example, the GUI 1000 includes allowing the user to select an obstacle type such as, for example, person, vehicle, station, or other. Various other obstacle types may be presented in GUI 1000.

The computational system 1100, shown in FIG. 11 can be used to perform any of the examples disclosed in this document. For example, computational system 1100 can be used to execute process 200 and/or process 300. As another example, computational system 1100 can perform any calculation, identification and/or determination described here. Computational system 1100 includes hardware elements that can be electrically coupled via a bus 1105 (or may otherwise be in communication, as appropriate). The hardware elements can include one or more processors 1110, including without limitation one or more general-purpose processors and/or one or more special-purpose processors (such as digital signal processing chips, graphics acceleration chips, and/or the like); one or more input devices 1115, which can include without limitation a mouse, a keyboard and/or the like; and one or more output devices 1120, which can include without limitation a display device, a printer and/or the like.

The computational system 1100 may further include (and/or be in communication with) one or more storage devices 1125, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 1100 might also include a communications subsystem 1130, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 1130 may permit data to be exchanged with a network (such as the network described below, to name one example), and/or any other devices described in this document. The computational system 1100, for example, may include a working memory 1135, which can include a RAM or ROM device, as described above.

The computational system 1100 also can include software elements, shown as being currently located within the working memory 1135, including an operating system 1140 and/or other code, such as one or more application programs 1145, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 1125 described above.

The storage medium, for example, might be incorporated within the computational system 1100 or in communication with the computational system 1100. The storage medium might be separate from a computational system 1100 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 1100 and/or might take the form of source and/or installable code, which, upon compilation and/or installation on the computational system 1100 (e.g., using any of a variety of generally available compilers, installation programs, compression/decompression utilities, etc.) then takes the form of executable code.

Although term “autonomous work vehicle” includes manned vehicles, remote control vehicles, manual vehicles, etc.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more examples disclosed in this document. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific examples, those skilled in the art, upon attaining an understanding of these examples, may readily produce alterations to, variations of, and equivalents to such examples. Accordingly, the present disclosure has been presented for purposes of example rather than limitation, and does not preclude inclusion of such modifications, variations and/or additions to the present subject matter as would be readily apparent to one of ordinary skill in the art.

1. An autonomous work vehicle comprising:
a transceiver;
an obstacle detection system;
a digital storage medium;
a steering control system;
a speed control system;
a camera; and
a controller in communication with the camera, the speed control system, the steering control system, the digital storage medium, the obstacle detection system, and the transceiver, the controller:
retrieves map data from the digital storage medium, the map defining features and a path within a work site;
directs the autonomous work vehicle to drive on or near the path using the steering control system and the speed control system;
detects an obstacle along the path using the obstacle detection system;
in response to detecting the obstacle in the path, stops the autonomous work vehicle using the steering control system and/or the speed control system;
records an image of the obstacle using the camera;
sends the image of the obstacle to a user via the transceiver;
receives a confirmation via the transceiver that the obstacle has been removed; and
in response to receiving the confirmation, drives the autonomous work vehicle along the path using the steering control system and the speed control system.

2. The autonomous work vehicle according to claim 1, wherein the autonomous work vehicle includes one or more lights, and wherein the controller:
turns on the lights in a first color when the autonomous work vehicle is following the path; and
turns on the lights in a second color when the autonomous work vehicle is stopped after detecting an obstacle.

3. The autonomous work vehicle according to claim 1, wherein the autonomous work vehicle includes one or more speakers or sirens, and wherein the controller:
transmits an audible alarm via the one or more speakers or sirens when the autonomous work vehicle is following the path; and
stops transmitting the audible alarm via the one or more speakers or sirens when the autonomous work vehicle is following the path.

4. The autonomous work vehicle according to claim 1, wherein the obstacle detection system comprises a LiDAR or a radar.

5. An autonomous work vehicle control system comprising:
an autonomous work vehicle that autonomously follows a path by viewing it's surrounding with one or more sensors; and
a mobile device with a graphical user interface that is in communication with the autonomous work vehicle the mobile device
receives sensor data from the autonomous work vehicle when the autonomous work vehicle encounters an obstacle or has a blind spot;
displays at least a portion of the sensor data to a user via the graphical user interface;
receives one or more responses from the user via the graphical user interface whether to allow the autonomous work vehicle to do one or more of the following continue along the path, to stop, or to wait until the user removes the obstacle; and
sends instructions to the autonomous work vehicle with instructions based on the received response from the user.

6. The autonomous work vehicle control system according to claim 5, wherein the sensor data comprises a photographic image of a field of view from the perspective of the autonomous work vehicle.

7. The autonomous work vehicle control system according to claim 5, further comprising displaying one or more buttons to the user via the graphical interface, wherein each button allows the user to select one of continue, stop, or wait.

8. The autonomous work vehicle control system according to claim 5, further comprising displaying a button to the user via the graphical interface, wherein the button allows the user to instruct the autonomous work vehicle to proceed despite any obstacles, and the mobile device sends instructions to the autonomous work vehicle to proceed along the path despite the presence of an obstacle.

9. The autonomous work vehicle control system according to claim 5, further comprising displaying one or more buttons to the user via the graphical interface, wherein the buttons allow the user to indicate whether an obstacle has been visually detected by the user.

10. (canceled)

11. (canceled)

12. (canceled)

13. (canceled)

14. (canceled)

15. (canceled)

16. (canceled)

17. (canceled)

18. An autonomous work vehicle comprising:
a transceiver;
an obstacle detection system;
a digital storage medium;
a steering control system;
a speed control system;
a camera; and
a controller in communication with the camera, the speed control system, the steering control system, the digital storage medium, the obstacle detection system, and the transceiver, the controller:
retrieves map data from the digital storage medium, the map defining features and a path within a work site;
directs the autonomous work vehicle to drive on or near the path using the steering control system and the speed control system;
detects a blind spot on or near the path using the obstacle detection system, a blind spot is an area on the map that cannot be viewed by obstacle detection subsystem;
in response to detecting the blind spot, stops the autonomous work vehicle using the steering control system and/or the speed control system;
records an image of the blind spot using the camera;
sends the image of the blind spot to a user via the transceiver;
receives a confirmation via the transceiver that the autonomous work vehicle can safely proceed into the blind spot; and
in response to receiving the confirmation, drives the autonomous work vehicle along the path and into the blind spot using the steering control system and the speed control system.

19. The autonomous work vehicle according to claim 18, wherein the autonomous work vehicle includes one or more lights, and wherein the controller:
turns on the lights in a first color when the autonomous work vehicle is following the path; and
turns on the lights in a second color when the autonomous work vehicle is stopped after detecting an obstacle.

20. The autonomous work vehicle according to claim 18, wherein the autonomous work vehicle includes one or more speakers or sirens, and wherein the controller:
transmits an audible alarm via the one or more speakers or sirens when the autonomous work vehicle is following the path; and
stops transmitting the audible alarm via the one or more speakers or sirens when the autonomous work vehicle is following the path.

21. The autonomous work vehicle according to claim 18, wherein the obstacle detection system comprises a LiDAR or a radar.
